(19) United States
(12) Patent Application Publication
(10) Pub. No.: US 2006/0135695 A1
(43) Pub. Date: Jun. 22, 2006

(54) Flexible poly(arylene ether) composition and articles thereof

(76) Inventors: Hua Guo, Selkirk, NY (US); Vijay R. Mhetar, Slingerlands, NY (US); Vijay Rajamani, Slingerlands, NY (US)

Correspondence Address: CANTOR COLBURN, LLP, 55 GRIFFIN ROAD SOUTH, BLOOMFIELD, CT, 06002, US

(21) Appl. No.: 11/256,766

(22) Filed: Oct. 24, 2005

Related U.S. Application Data
(60) Provisional application No. 60/637,008, filed on Dec. 17, 2004.
(60) Provisional application No. 60/637,412, filed on Dec. 17, 2004.
(60) Provisional application No. 60/637,419, filed on Dec. 17, 2004.

(51) Int. Cl. C08L 53/00

(52) U.S. Cl. 525/92 D

(57) ABSTRACT

A thermoplastic composition comprising a poly(arylene ether), a polyolefin, and a polymeric compatibilizer selected from the group consisting of (i) a block copolymer wherein a central block is a controlled distribution copolymer, and (ii) a polypropylene-polystyrene graft copolymer; is disclosed. The composition is useful in the production of covered wire.

### CROSS REFERENCE TO RELATED APPLICATIONS

This application claims priority to U.S. Provisional Application Ser. Nos. 60/637,008, 60/637,412, and 60/637,419 filed on Dec. 17, 2004, all of which are incorporated in their entirety by reference herein.

### BACKGROUND OF INVENTION

This disclosure relates to flexible thermoplastic compositions. In particular, the disclosure relates to flexible poly(arylene ether) compositions.

Polyvinyl chloride resins have long been used as the coating resin in the covered wire and cable industry. However, there is mounting concern over the environmental impact of halogenated materials and non-halogenated alternatives are being sought. This search has met with some success in polyethylene compositions however useful polyethylene compositions typically have high levels of inorganic flame retardants that can result in deterioration of some mechanical properties and processability.

Additionally, as electronic devices become increasingly smaller and transportable there is an increasing need for the cables and wires employed as part of these devices and their accessories to be more flexible and durable. For example, as the number of electronic components of automotive engines increase there is an increasing need for the wires connecting the electronic components to be flexible and durable over a range of temperatures and after exposure to the various chemicals found in an automotive environment.

Accordingly, there is a need for a flexible thermoplastic composition with excellent mechanical properties and processability, which is important to the durability and cost effectiveness of covered wires and cables made using the flexible thermoplastic composition.

### BRIEF DESCRIPTION OF THE INVENTION

The above described need is met by a thermoplastic composition comprising:

a poly(arylene ether) having an initial intrinsic viscosity greater than 0.25 dl/g as measured in chloroform at 25° C.;

a polyolefin having a melt temperature greater than or equal to 120° C. and a melt flow rate of 0.3 to 15; and

a polymeric compatibilizer selected from the group consisting of

(i) a combination of diblock and triblock copolymers,

(ii) a block copolymer wherein a central block is a controlled distribution copolymer

(iii) a combination of a polypropylene-polystyrene graft copolymer and a block copolymer;

wherein the poly(arylene ether) is present in an amount by weight greater than the amount of polyolefin by weight. The composition may further comprise a flame retardant.

A covered conductor comprising:

a conductor; and

a covering comprising a thermoplastic composition and the thermoplastic composition comprises:

a poly(arylene ether) having an initial intrinsic viscosity greater than 0.25 dl/g as measured in chloroform at 25° C.;

a polypropylene having a melt temperature greater than or equal to 120° C. and a melt flow rate of 0.3 to 15;

a polymeric compatibilizer selected from the group consisting of

(i) a combination of diblock and triblock block copolymers,

(ii) a block copolymer comprising a controlled distribution copolymer midblock, and

(iii) a combination of a polypropylene-polystyrene graft copolymer and a block copolymer;

wherein the poly(arylene ether) is present in an amount by weight greater than the amount of polyolefin by weight and

wherein the covering is disposed over the conductor. The thermoplastic composition may further comprise a flame retardant.

### BRIEF DESCRIPTION OF THE DRAWINGS

FIGS. 1-2 are transmission electron micrographs of thermoplastic compositions described herein.

FIG. 3 is a schematic representation of a cross-section of electrical wire.

FIGS. 4 and 5 are perspective views of an electrical wire having multiple layers.

### DETAILED DESCRIPTION

In this specification and in the claims, which follow, reference will be made to a number of terms which shall be defined to have the following meanings.

The singular forms “a,” “an,” and “the” include plural referents unless the context clearly dictates otherwise.

“Optional” or “optionally” means that the subsequently described event or circumstance may or may not occur, and that the description includes instances where the event occurs and instances where it does not.

The endpoints of all ranges reciting the same characteristic are independently combinable and inclusive of the recited endpoint. Values expressed as “greater than” or “less than” are inclusive the stated endpoint, e.g., “greater than 3.5” encompasses the value of 3.5.

ISO 6722, as referred to herein, is the Dec. 15, 2002 version of this standard.

The composition described herein comprises at least two phases, a polyolefin phase and a poly(arylene ether) phase. The polyolefin phase is a continuous phase. The poly(arylene ether) phase may be dispersed in the polyolefin phase. Good compatibilization between the phases can result in improved physical properties including higher impact strength at low temperatures and room temperature, better heat aging, better flame retardance, as well as greater tensile elongation. It is generally accepted that the morphology of the composition is indicative of the degree or quality of compatibilization. Small, relatively uniformly sized particles of poly(arylene ether) evenly distributed throughout an area of the composition are indicative of good compatibilization.

The compositions described herein are essentially free of an alkenyl aromatic resin such as polystyrene or rubber-modified polystyrene (also known as high impact polystyrene or HIPS). Essentially free is defined as containing less than 10 weight percent (wt %), or, more specifically less than 7 wt %, or, more specifically less than 5 wt %, or, even more specifically less than 3 wt % of an alkenyl aromatic resin, based on the combined weight of poly(arylene ether), polyolefin and block copolymer(s). Surprisingly the presence of the alkenyl aromatic resin can negatively affect the compatibilization between the poly(arylene ether) phase and the polyolefin phase.

In some embodiments the composition has poly(arylene ether) particles dispersed in the continuous polyolefin phase. When the composition is injection molded or extruded, particularly when extruded to form a covered wire, the poly(arylene ether) particles may have an average diameter less than 5 micrometers or more specifically, less than or equal to 3 micrometers, or, even more specifically, less than or equal to 2 micrometers. As readily appreciated by one of ordinary skill in the art the poly(arylene ether) particles may have spherical or non-spherical shapes. The shape of the particles may be dependent upon molding or extruding conditions, particularly the amount of shear present during article formation. When the particle shape is non-spherical the diameter of the particle is defined as the longest linear dimension. This can alternately be described as the major axis.

In some embodiments the composition has poly(arylene ether) particles dispersed in the continuous polyolefin phase. When the composition is injection molded or extruded the poly(arylene ether) particles have an average particle area less than or equal to 4 square micrometers (μm²), or, more specifically, less than or equal to 2 square micrometers, or, even more specifically, less than or equal to 1 square micrometer determined as described below.

The average diameter and/or particle area of the poly(arylene ether) particles in an injection molded item may be determined using transmission electron microscopy. The composition is injection molded into a disc having a 3.2 millimeters thickness as is used in an ASTM D3763-03 test. A portion located at the center (in terms of diameter) of the disc is removed and then sections having a thickness of 100 nanometers are removed from the center (in terms of thickness) of the portion. The sections are stained in freshly prepared ruthenium tetraoxide staining solution for 30 seconds. The microscopy studies may be performed on an electron microscope such as a Technai G2. Digital image acquisition may be performed using a camera such as a Gatan Model 791 side mount camera. Images may be analyzed using image analysis software such as Clemex Vision PE to determine the average diameter or average particle area. Only particles that have boundaries completely within the viewing area are included in the analysis. The analysis and the average values are based on at least 100 particles.

The average diameter and/or particle area of the poly(arylene ether) particles in an extruded item, such as a covered wire, may be determined by removing a portion of the extruded thermoplastic and then sections having a thickness of 100 nanometers are removed from the portion at a depth of 50-60 micrometers from the surface. The sections are stained in freshly prepared ruthenium tetraoxide staining solution for 30 seconds. The microscopy studies may be performed on an electron microscope such as a Technai G2. Digital image acquisition may be performed using a camera such as a Gatan Model 791 side mount camera. Images may be analyzed using image analysis software such as Clemex Vision PE to determine the average diameter or the particle area. Only particles that have boundaries completely within the viewing area are included in the analysis. The analysis and average values are based on at least 100 particles.

Surprisingly, the intrinsic viscosity of the poly(arylene ether) and the melt flow index of the polyolefin can have an impact on the morphology of the composition. In one embodiment, the poly(arylene ether) or combination of poly(arylene ether)s has an initial intrinsic viscosity greater than 0.31 dl/g as measured in chloroform at 25° C. and the polyolefin has a melt flow rate of 0.8 to 15 grams per ten minutes when determined according to ASTM D1238. When the poly(arylene ether) or combination of poly(arylene ethers) has an initial intrinsic viscosity less than 0.31 dl/g, the composition may demonstrate diminished heat aging. When the polyolefin has a melt flow greater than or equal to 15 grams per ten minutes the composition may have diminished chemical resistance and heat aging. When the polyolefin has a melt flow less than or equal to 0.7 grams per ten minutes, the composition can have a co-continuous morphology and unacceptable mechanical properties (i.e. tensile elongation) for some applications.

As suggested above the thermoplastic composition is useful in covered conductors, particularly covered wires employed in environments where they may be exposed to chemicals, such as gasoline, diesel fuel, antifreeze, and the like, that can result in degradation. In another aspect the composition has desirable adhesion to the wire. Adhesion must be sufficient to maintain the integrity of the wire under normal use but not so strong as to prevent intentional stripping. Typically a force of about 2 to 100 Newtons, depending on the size of the conductor and thickness of the thermoplastic coating, is employed to strip the thermoplastic coating from a wire so it is desirable that the covered wire has an adhesion strength between the conductor and the thermoplastic composition that is less than or equal to the stripping force typically employed for the conductor size and thermoplastic coating thickness. Exemplary stripping forces for various conductor sizes may be found in ISO 6722.

In another aspect the covered wire comprising the thermoplastic composition described herein meet or exceed the standards set forth in ISO 6722, such as flame retardance, heat aging, and abrasion, making the covered wire suitable for use is road vehicles. In particular the covered wire meets or exceeds the heat aging standards for Classes A, B or C as set forth in ISO 6722.

In another aspect the composition has a flexural modulus of 800-1800 Megapascals (MPa) as determined by ASTM D790-03 and a speed of 1.27 millimeters per minute at thickness of 3.2 millimeters. Within this range the flexural modulus may be greater than or equal to 900 MPa, or, more specifically, greater than or equal to 1200 MPa. Also within this range the flexural modulus may be less than or equal to 1700 MPa, or, more specifically, less than or equal to 1600 MPa. Flexural modulus values are the average of three samples. The samples for flexural modulus are formed using an injection pressure of 600-700 kilograms-force per square centimeter and a hold time of 15 to 20 seconds on a Plastar Ti-80G₂ from Toyo Machinery & Metal co. LTD. The remaining molding conditions are shown in Table 1.

TABLE 1

| | |
|---|---|
| Drying temperature (° C.) | 80 |
| Dry time in hours | 4 |
| Cylinder temperature | |
| 1 | 240 |
| 2 | 250 |
| 3 | 260 |
| 4 | 260 |
| DH | 260 |
| Mold temperature | 80 |

As used herein, a “poly(arylene ether)” comprises a plurality of structural units of the formula (I): 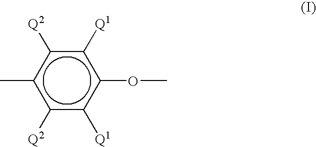
wherein for each structural unit, each Q¹ and Q² is independently hydrogen, halogen, primary or secondary lower alkyl (e.g., an alkyl containing 1 to about 7 carbon atoms), phenyl, haloalkyl, aminoalkyl, alkenylalkyl, alkynylalkyl, hydrocarbonoxy, aryl and halohydrocarbonoxy wherein at least two carbon atoms separate the halogen and oxygen atoms. In some embodiments, each Q¹ is independently alkyl or phenyl, for example, C₁₋₄ alkyl, and each Q² is independently hydrogen or methyl. The poly(arylene ether) may comprise molecules having aminoalkyl-containing end group(s), typically located in an ortho position to the hydroxy group. Also frequently present are tetramethyl diphenylquinone (TMDQ) end groups, typically obtained from reaction mixtures in which tetramethyl diphenylquinone by-product is present.

The poly(arylene ether) may be in the form of a homopolymer; a copolymer; a graft copolymer; an ionomer; or a block copolymer; as well as combinations comprising at least one of the foregoing. Poly(arylene ether) includes polyphenylene ether comprising 2,6-dimethyl-1,4-phenylene ether units optionally in combination with 2,3,6-trimethyl-1,4-phenylene ether units.

The poly(arylene ether) may be prepared by the oxidative coupling of monohydroxyaromatic compound(s) such as 2,6-xylenol and/or 2,3,6-trimethylphenol. Catalyst systems are generally employed for such coupling; they can contain heavy metal compound(s) such as a copper, manganese or cobalt compound, usually in combination with various other materials such as a secondary amine, tertiary amine, halide or combination of two or more of the foregoing.

In one embodiment, the poly(arylene ether) comprises a capped poly(arylene ether). The terminal hydroxy groups may be capped with a capping agent via an acylation reaction, for example. The capping agent chosen is desirably one that results in a less reactive poly(arylene ether) thereby reducing or preventing crosslinking of the polymer chains and the formation of gels or black specks during processing at elevated temperatures. Suitable capping agents include, for example, esters of salicylic acid, anthranilic acid, or a substituted derivative thereof, and the like; esters of salicylic acid, and especially salicylic carbonate and linear polysalicylates, are preferred. As used herein, the term “ester of salicylic acid” includes compounds in which the carboxy group, the hydroxy group, or both have been esterified. Suitable salicylates include, for example, aryl salicylates such as phenyl salicylate, acetylsalicylic acid, salicylic carbonate, and polysalicylates, including both linear polysalicylates and cyclic compounds such as disalicylide and trisalicylide. The preferred capping agents are salicylic carbonate and the polysalicylates, especially linear polysalicylates. When capped, the poly(arylene ether) may be capped to any desirable extent up to 80 percent, more specifically up to about 90 percent, and even more specifically up to 100 percent of the hydroxy groups are capped. Suitable capped poly(arylene ether) and their preparation are described in U.S. Pat. No. 4,760,118 to White et al. and U.S. Pat. No. 6,306,978 to Braat et al.

Capping poly(arylene ether) with polysalicylate is also believed to reduce the amount of aminoalkyl terminated groups present in the poly(arylene ether) chain. The aminoalkyl groups are the result of oxidative coupling reactions that employ amines in the process to produce the poly(arylene ether). The aminoalkyl group, ortho to the terminal hydroxy group of the poly(arylene ether), can be susceptible to decomposition at high temperatures. The decomposition is believed to result in the regeneration of primary or secondary amine and the production of a quinone methide end group, which may in turn generate a 2,6-dialkyl-1-hydroxyphenyl end group. Capping of poly(arylene ether) containing aminoalkyl groups with polysalicylate is believed to remove such amino groups to result in a capped terminal hydroxy group of the polymer chain and the formation of 2-hydroxy-N,N-alkylbenzamine (salicylamide). The removal of the amino group and the capping provides a poly(arylene ether) that is more stable to high temperatures, thereby resulting in fewer degradative products, such as gels or black specks, during processing of the poly(arylene ether).

The poly(arylene ether) can have a number average molecular weight of about 3,000 to about 40,000 grams per mole (g/mol) and a weight average molecular weight of about 5,000 to about 80,000 g/mol, as determined by gel permeation chromatography using monodisperse polystyrene standards, a styrene divinyl benzene gel at 40° C. and samples having a concentration of 1 milligram per milliliter of chloroform. The poly(arylene ether) or combination of poly(arylene ether)s can have an initial intrinsic viscosity greater than or equal to 0.25 deciliters per gram (dl/g), as measured in chloroform at 25° C. In one embodiment, the poly(arylene ether) or combination of poly(arylene ether)s have an initial intrinsic viscosity greater than or equal to 0.35 deciliters per gram (dl/g), as measured in chloroform at 25° C. Initial intrinsic viscosity is defined as the intrinsic viscosity of the poly(arylene ether) prior to melt mixing with the other components of the composition and final intrinsic viscosity is defined as the intrinsic viscosity of the poly(arylene ether) after melt mixing with the other components of the composition. As understood by one of ordinary skill in the art the viscosity of the poly(arylene ether) may be up to 30% higher after melt mixing. The percentage of increase can be calculated by (final intrinsic viscosity—initial intrinsic viscosity)/initial intrinsic viscosity. Determining an exact ratio, when two intrinsic viscosities are used, will depend somewhat on the exact intrinsic viscosities of the poly(arylene ether) used and the ultimate physical properties that are desired.

The poly(arylene ether) may have a hydroxy end group content of less than or equal to 6300 parts per million based on the total weight of the poly(arylene ether) (ppm) as determined by Fourier Transform Infrared Spectrometry (FTIR). In one embodiment the poly(arylene ether) may have a hydroxy end group content of less than or equal to 3000 ppm, or, more specifically, less than or equal to 1500 ppm, or, even more specifically, less than or equal to 500 ppm.

The poly(arylene ether) may be substantially free of visible particulate impurities. In one embodiment, the poly(arylene ether) is substantially free of particulate impurities greater than about 15 micrometers. As used herein, the term “substantially free of visible particulate impurities” when applied to poly(arylene ether) means that a ten gram sample of a polymeric material dissolved in fifty milliliters of chloroform (CHCl₃) exhibits fewer than 5 visible specks when viewed in a light box. Particles visible to the naked eye are typically those greater than 40 micrometers in diameter. As used herein, the term “substantially free of particulate impurities greater than about 15 micrometers” means that of a forty gram sample of polymeric material dissolved in 400 milliliters of CHCl₃, the number of particulates per gram having a size of about 15 micrometers is less than 50, as measured by a Pacific Instruments ABS2 analyzer based on the average of five samples of twenty milliliter quantities of the dissolved polymeric material that is allowed to flow through the analyzer at a flow rate of one milliliter per minute (plus or minus five percent).

The composition may comprise the poly(arylene ether) in an amount of about 30 to about 65 weight percent (wt %), based on the combined weight of the poly(arylene ether), polyolefin, polymeric compatibilizer and optional fire retardant. Within this range the amount of poly(arylene ether) may be greater than or equal to about 40 wt %, or, more specifically, greater than or equal to about 45 wt %. Also within this range the amount of poly(arylene ether) may be less than or equal to about 60 wt %.

Polyolefins are of the general structure: CₙH₂ₙ and include polyethylene, polypropylene and polyisobutylene with exemplary homopolymers being atactic polypropylene, and isotatic polypropylene. Polyolefin resins of this general structure and methods for their preparation are well known in the art and are described for example in U.S. Pat. Nos. 2,933,480, 3,093,621, 3,211,709, 3,646,168, 3,790,519, 3,884,993, 3,894,999, 4,059,654, 4,166,055 and 4,584,334. In one embodiment the polyolefin consists essentially of a polyolefin homopolymer, or, more specifically, a crystalline polyolefin homopolymer.

Copolymers of polyolefins may also be used such copolymers of polypropylene with rubber copolymers or copolymers of polyethylene with rubber copolymers. The copolymer may include copolymers such as ethylene octene rubber and ethylene butadiene for example. Such copolymers are typically heterophasic and have sufficiently long sections of each component to have both amorphous and crystalline phases. Additionally the polyolefin may comprise a combination of homopolymer and copolymer, a combination of homopolymers having different melt temperatures, and/or a combination of homopolymers having a different melt flow rate.

In one embodiment the polyolefin comprises a crystalline polyolefin such as isotactic polypropylene. Crystalline polyolefins area defined as polyolefins having a crystallinity content greater than or equal to 20%, or, more specifically, greater than or equal to 25%, or, even more specifically, greater than or equal to 30%. Crystallinity may be determined by differential scanning calorimetry (DSC).

The polyolefin has a melt temperature greater than or equal to 120° C. or, more specifically, greater than or equal to 125° C., or, more specifically, greater than or equal to 130° C., or, even more specifically, greater than or equal to 135° C.

The polyolefin has a melt flow rate (MFR) greater than or equal to 0.3 grams per 10 minutes and less than or equal to 15 grams per ten minutes (g/10 min). Within this range the melt flow rate may be greater than or equal to 0.7 grams per 10 minutes, or, more specifically, greater than or equal to 1.0 g/10 min. Also within this range the melt flow rate may be less than or equal to 10, or, more specifically, less than or equal to 6, or, more specifically, less than or equal to 5 g/10 min. Melt flow rate can be determined according to ASTM D1238 using either powdered or pelletized polyolefin, a load of 2.16 kilograms and a temperature suitable for the resin (190° C. for ethylene based resins and 230° C. for propylene based resins).

The composition may comprise the polyolefin in an amount of 20 to 40 weight percent (wt %), based on the combined weight of the poly(arylene ether), polyolefin, polymeric compatibilizer, and optional fire retardant. Within this range the amount of polyolefin may be greater than or equal to 23 wt %, or, more specifically, greater than or equal to about 25 wt %. Also within this range the amount of polyolefin may be less than or equal to about 35 wt %, or, more specifically, less than or equal to about 33 wt %.

Polymeric compatibilizers are resins and additives that improve the compatibility between the polyolefin phase and the poly(arylene ether) phase. Polymeric compatibilizers include block copolymers, and combinations of block copolymers and polypropylene-polystyrene graft copolymers as described below.

As used herein and throughout the specification “block copolymer” refers to a single block copolymer or a combination of block copolymers. The block copolymer comprises at least one block (A) comprising repeating aryl alkylene units and at least one block (B) comprising repeating alkylene units. The arrangement of blocks (A) and (B) may be a linear structure or a so-called radial teleblock structure having branched chains. The pendant aryl moiety of the aryl alkylene units may be monocyclic or polycyclic and may have a substituent at any available position on the cyclic portion. Suitable substituents include alkyl groups having 1 to 4 carbons. An exemplary aryl alkylene unit is phenylethylene, which is shown in Formula II: 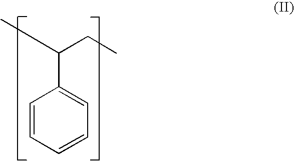
Block A may further comprise alkylene units having 2 to 15 carbons as long as the quantity of aryl alkylene units exceeds the quantity of alkylene units.

Block B comprises repeating alkylene units having 2 to 15 carbons such as ethylene, propylene, butylene or combinations of two or more of the foregoing. Block B may further comprise aryl alkylene units as long as the quantity of alkylene units exceeds the quantity of aryl alkylene units.

Each occurrence of block A may have a molecular weight which is the same or different than other occurrences of block A. Similarly each occurrence of block B may have a molecular weight which is the same or different than other occurrences of block B. The block copolymer may be functionalized by reaction with an alpha-beta unsaturated carboxylic acid.

In one embodiment, the B block comprises a copolymer of aryl alkylene units and alkylene units having 2 to 15 carbons such as ethylene, propylene, butylene or combinations of two or more of the foregoing. The B block may further comprise some unsaturated non-aromatic carbon-carbon bonds.

The repeating aryl alkylene units result from the polymerization of aryl alkylene monomers such as styrene. The repeating alkylene units result from the hydrogenation of repeating unsaturated units derived from a diene such as butadiene. The butadiene may comprise 1,4-butadiene and/or 1,2-butadiene. The B block may further comprise some unsaturated non-aromatic carbon-carbon bonds.

Exemplary block copolymers include polyphenylethylene-poly(ethylene/propylene)-polyphenylethylene (sometimes referred to as polystyrene-poly(ethylene/propylene)-polystyrene) and polyphenylethylene-poly(ethylene/butylene)-polyphenylethylene (sometimes referred to as polystyrene-poly(ethylene/butylene)-polystyrene).

In one embodiment, the polymeric compatibilizer comprises a diblock block copolymer and a triblock block copolymer. Exemplary triblock copolymers are commercially available from Asahi under the trademark TUFTEC and have grade names such as H1043, as well as some grades available under the tradename SEPTON from Kuraray. Other exemplary triblock copolymers are commercially available from Kraton Polymers under the trademark KRATON and have grade names such as G-1650, G-1651, and G-1652. Exemplary diblock copolymers are commercially available from Kraton Polymers under the trademark KRATON and have grade names such as G-1701, G-1702, and G-1730.

In one embodiment the polymeric compatibilizer is a block copolymer wherein a central block (a B block) is a controlled distribution copolymer. As used herein “controlled distribution” is defined as referring to a molecular structure lacking well-defined blocks of either monomer, with “runs” of any given single monomer attaining a maximum number average of 20 units as shown by either the presence of only a single glass transition temperature (Tg), intermediate between the Tg of either homopolymer, or as shown via proton nuclear magnetic resonance methods. When the B block comprises a controlled distribution copolymer, each A block may have an average molecular weight of 3,000 to 60,000 g/mol and each B block may have an average molecular weight of 30,000 to 300,000 g/mol, as determined using light scattering techniques. When the B block is a controlled distribution polymer, each B block comprises at least one terminal region adjacent to an A block that is rich in alkylene units and a region not adjacent to the A block that is rich in aryl alkylene units. The total amount of aryl alkylene units is 15 to 75 weight percent, based on the total weight of the block copolymer. The weight ratio of alkylene units to aryl alkylene units in the B block may be 5:1 to 1:2. Exemplary block copolymers are further disclosed in U.S. Patent Application No. 2003/181584 and are commercially available from Kraton Polymers under the trademark KRATON. Exemplary grades are A-RP6936 and A-RP6935.

In some embodiments the block copolymer has a number average molecular weight of 5,000 to 1,000,000 grams per mole (g/mol), as determined by gel permeation chromatography (GPC) using polystyrene standards. Within this range, the number average molecular weight may be at least 10,000 g/mol, or, more specifically, at least 30,000 g/mol, or, even more specifically, at least 45,000 g/mol. Also within this range, the number average molecular weight may preferably be up to 800,000 g/mol, or, more specifically, up to 700,000 g/mol, or, even more specifically, up to 650,000 g/mol.

A polypropylene-polystyrene graft copolymer is herein defined as a graft copolymer having a propylene polymer backbone and one or more styrene polymer grafts.

The propylene polymer material that forms the backbone or substrate of the polypropylene-polystyrene graft copolymer is (a) a homopolymer of propylene; (b) a random copolymer of propylene and an olefin selected from the group consisting of ethylene and C₄-C₁₀ olefins, provided that, when the olefin is ethylene, the polymerized ethylene content is up to about 10 weight percent, preferably up to about 4 weight percent, and when the olefin is a C₄-C₁₀ olefin, the polymerized content of the C₄-C₁₀ olefin is up to about 20 weight percent, preferably up to about 16 weight percent; (c) a random terpolymer of propylene and at least two olefins selected from the group consisting of ethylene and C₄-C₁₀ alpha-olefins, provided that the polymerized C₄-C₁₀ alpha-olefin content is up to about 20 weight percent, preferably up to about 16 weight percent, and, when ethylene is one of the olefins, the polymerized ethylene content is up to about 5 weight percent, preferably up to about 4 weight percent; or (d) a homopolymer or random copolymer of propylene which is impact-modified with an ethylene-propylene monomer rubber in the reactor as well as by physical blending, the ethylene-propylene monomer rubber content of the modified polymer being about 5 to about 30 weight percent, and the ethylene content of the rubber being about 7 to about 70 weight percent, and preferably about 10 to about 40 weight percent. The C₄-C₁₀ olefins include the linear and branched C₄-C₁₀ alpha-olefins such as, for example, 1-butene, 1-pentene, 3-methyl-1-butene, 4-methyl-1-pentene, 1-hexene, 3,4-dimethyl-1-butene, 1-heptene, 1-octene, 3-methyl-hexene, and the like. Propylene homopolymers and impact-modified propylene homopolymers are preferred propylene polymer materials. Although not preferred, propylene homopolymers and random copolymers impact modified with an ethylene-propylene-diene monomer rubber having a diene content of about 2 to about 8 weight percent also can be used as the propylene polymer material. Suitable dienes include dicyclopentadiene, 1,6-hexadiene, ethylidene norbornene, and the like.

The term “styrene polymer”, used in reference to the grafted polymer present on the backbone of propylene polymer material in the polypropylene-polystyrene graft copolymer, denotes (a) homopolymers of styrene or of an alkyl styrene having at least one C₁-C₄ linear or branched alkyl ring substituent, especially a p-alkyl styrene; (b) copolymers of the (a) monomers with one another in all proportions; and (c) copolymers of at least one (a) monomer with alpha-methyl derivatives thereof, e.g., alpha-methylstyrene, wherein the alpha-methyl derivative constitutes about 1 to about 40% of the weight of the copolymer.

The polypropylene-polystyrene graft copolymer can comprise about 10 to about 90 weight percent of the propylene polymer backbone and about 90 to about 10 weight percent of the styrene polymer graft. Within these ranges, the propylene polymer backbone may account for at least about 20 weight percent, of the total graft copolymer; and the propylene polymer backbone may account for up to about 40 weight percent of the total graft copolymer. Also within these ranges, the styrene polymer graft may account for at least about 50 weight percent, or, more specifically, at least about 60 weight percent, of the total graft copolymer.

The preparation of polypropylene-polystyrene graft copolymers is described, for example, in U.S. Pat. No. 4,990,558 to DeNicola, Jr. et al. Suitable polypropylene-polystyrene graft copolymers are also commercially available as, for example, P1045H1 and P1085H1 from Basell.

In one embodiment the polymeric compatibilizer is a combination of polypropylene-polystyrene graft copolymer and block copolymer.

The polymeric compatibilizer is present in an amount of 2 to 20 weight percent, with respect to the combined weight of the poly(arylene ether), polyolefin, polymeric compatibilizer and optional fire retardant. Within this range the polymeric compatibilizer may be present in an amount greater than or equal to 4 weight percent, or, more specifically, greater than or equal to 6 weight percent with respect to the total weight of the composition. Also within this range the polymeric compatibilizer may be present in an amount less than or equal to 18, or, more specifically, less than or equal to 16, or, even more specifically, less than or equal to 14 weight percent with respect to the total weight of the composition.

Exemplary flame retardants include melamine (CAS No. 108-78-1), melamine cyanurate (CAS No. 37640-57-6), melamine phosphate (CAS No. 20208-95-1), melamine pyrophosphate (CAS No. 15541-60-3), melamine polyphosphate (CAS No. 218768-84-4), melam, melem, melon, zinc borate (CAS No. 1332-07-6), boron phosphate, red phosphorous (CAS No. 7723-14-0), organophosphate esters, monoammonium phosphate (CAS No. 7722-76-1), diammonium phosphate (CAS No. 7783-28-0), alkyl phosphonates (CAS No. 78-38-6 and 78-40-0), metal dialkyl phosphinate, ammonium polyphosphates (CAS No. 68333-79-9), low melting glasses and combinations of two or more of the foregoing flame retardants.

Exemplary organophosphate ester flame retardants include, but are not limited to, phosphate esters comprising phenyl groups, substituted phenyl groups, or a combination of phenyl groups and substituted phenyl groups, bis-aryl phosphate esters based upon resorcinol such as, for example, resorcinol bis-diphenylphosphate, as well as those based upon bis-phenols such as, for example, bis-phenol A bis-diphenylphosphate. In one embodiment, the organophosphate ester is selected from tris(alkylphenyl) phosphate (for example, CAS No. 89492-23-9 or CAS No. 78-33-1), resorcinol bis-diphenylphosphate (for example, CAS No. 57583-54-7), bis-phenol A bis-diphenylphosphate (for example, CAS No. 181028-79-5), triphenyl phosphate (for example, CAS No. 115-86-6), tris(isopropylphenyl) phosphate (for example, CAS No. 68937-41-7) and mixtures of two or more of the foregoing organophosphate esters.

In one embodiment the organophosphate ester comprises a bis-aryl phosphate of Formula III: 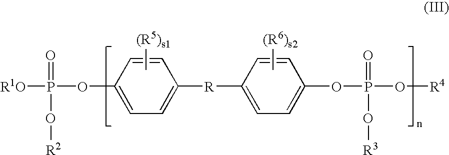
wherein R, R⁵ and R⁶ are independently at each occurrence an alkyl group having 1 to 5 carbons and R¹—R⁴ are independently an alkyl, aryl, arylalkyl or alkylaryl group having 1 to 10 carbons; n is an integer equal to 1 to 25; and s1 and s2 are independently an integer equal to 0 to 2. In some embodiments OR¹, OR², OR³ and OR⁴ are independently derived from phenol, a monoalkylphenol, a dialkylphenol or a trialkylphenol.

As readily appreciated by one of ordinary skill in the art, the bis-aryl phosphate is derived from a bisphenol. Exemplary bisphenols include 2,2-bis(4-hydroxyphenyl)propane (so-called bisphenol A), 2,2-bis(4-hydroxy-3-methylphenyl)propane, bis(4-hydroxyphenyl)methane, bis(4-hydroxy-3,5-dimethylphenyl)methane and 1,1-bis(4-hydroxyphenyl)ethane. In one embodiment, the bisphenol comprises bisphenol A.

Organophosphate esters can have differing molecular weights making the determination of the amount of different organophosphate esters used in the thermoplastic composition difficult. In one embodiment the amount of phosphorus, as the result of the organophosphate ester, is 0.8 weight percent to 1.2 weight percent with respect to the combined weight of the poly(arylene ether), polyolefin, polymeric compatibilizer, and optional fire retardant.

The amount of the flame retardant, when present in the thermoplastic composition, is sufficient for the covered conductor to pass the relevant flame retardance standard to the type of covered conductor. For example, when the covered conductor is an electrical wire for automotive applications the amount of flame retardant is sufficient for the electrical wire to have a flame out time less than or equal to 70 seconds, when tested according to the flame propagation procedure contained in ISO 6722.

In one embodiment, the flame retardant comprises an organophosphate ester present in an amount of 5 to 18 weight percent (wt. %), with respect to the combined weight of the poly(arylene ether), polyolefin, polymeric compatibilizer, and optional fire retardant. Within this range the amount of organophosphate ester can be greater than or equal to 7 wt. %, or more specifically, greater than or equal to 9 wt. %. Also within this range the amount of organophosphate ester can be less than or equal to 16 wt. %, or, more specifically, less than or equal to 14 wt. %.

Additionally, the composition may optionally also contain various additives, such as antioxidants; fillers and reinforcing agents having an average particle size less than or equal to 10 micrometers, such as, for example, silicates, TiO₂, fibers, glass fibers, glass spheres, calcium carbonate, talc, and mica; mold release agents; UV absorbers; stabilizers such as light stabilizers and others; lubricants; plasticizers; pigments; dyes; colorants; anti-static agents; foaming agents; blowing agents; metal deactivators, and combinations comprising one or more of the foregoing additives.

A method for making the thermoplastic composition comprises melt mixing (compounding) the components, typically in a melt mixing device such as an compounding extruder or Banbury mixer. In one embodiment, the poly(arylene ether), polymeric compatibilizer, and polyolefin are simultaneously melt mixed. In another embodiment, the poly(arylene ether), polymeric compatibilizer, and optionally a portion of the polyolefin are melt mixed to form a first melt mixture. Subsequently, the polyolefin or remainder of the polyolefin is further melt mixed with the first melt mixture to form a second melt mixture. Alternatively, the poly(arylene ether) and a portion of the polymeric compatibilizer may be melt mixed to form a first melt mixture and then the polyolefin and the remainder of the polymeric compatibilizer are further melt mixed with the first melt mixture to form a second melt mixture.

The aforementioned melt mixing processes can be achieved without isolating the first melt mixture or can be achieved by isolating the first melt mixture. One or more melt mixing devices including one or more types of melt mixing devices can be used in these processes. In one embodiment, some components of the thermoplastic composition that forms the covering may be introduced and melt mixed in an extruder used to coat the conductor.

In one embodiment, the poly(arylene ether) and the block copolymer having an aryl alkylene content greater than or equal to 50 weight percent can be melt mixed to form a first melt mixture and the polyolefin and a block copolymer having an aryl alkylene content less than 50 weight percent can be compounded with the first melt mixture to form a second melt mixture.

The method and location of the addition of the flame retardant is typically dictated by the identity and physical properties, e.g., solid or liquid, of the flame retardant as well understood in the general art of polymer alloys and their manufacture. In one embodiment, the flame retardant is combined with one of the components of the thermoplastic composition, e.g., a portion of the polyolefin, to form a concentrate that is subsequently melt mixed with the remaining components.

The poly(arylene ether), polymeric compatibilizer, polyolefin and flame retardant are melt mixed at a temperature greater than or equal to the glass transition temperature of the poly(arylene ether) but less than the degradation temperature of the polyolefin. For example, the poly(arylene ether), polymeric compatibilizer, polyolefin and flame retardant may be melt mixed at an extruder temperature of 240° C. to 320° C., although brief periods in excess of this range may occur during melt mixing. Within this range, the temperature may be greater than or equal to 250° C., or, more specifically, greater than or equal to 260° C. Also within this range the temperature may be less than or equal to 310° C., or, more specifically, less than or equal to 300° C.

After some or all the components are melt mixed, the molten mixture can be melt filtered through one of more filters. In one embodiment the one or more filters have openings with diameters of 20 micrometers to 150 micrometers. Within this range, the openings may have diameters less than or equal to 130 micrometers, or, more specifically, less than or equal to 110 micrometers. Also within this range the openings can have diameters greater than or equal to 30 micrometers, or, more specifically, greater than or equal to 40 micrometers.

In one embodiment, the filter openings have a maximum diameter that is less than or equal to half of the thickness of the covering that will be applied to the conductor. For example, if the covered conductor has a covering with a thickness of 200 micrometers, the filter openings have a maximum diameter less than or equal to 100 micrometers.

Any suitable melt filtration system or device that can remove particulate impurities from the molten mixture may be used. In one embodiment the melt is filtered through a single melt filtration system. Multiple melt filtration systems are also contemplated.

Suitable melt filtration systems include filters made from a variety of materials such as, but not limited to, sintered-metal, metal mesh or screen, fiber metal felt, ceramic, or a combination of the foregoing materials, and the like. Particularly useful filters are sintered metal filters exhibiting high tortuosity, including the sintered wire mesh filters prepared by Pall Corporation and Martin Kurz & Company, Inc.

In one embodiment the melt filtered mixture is passed through a die head and pelletized by either strand pelletization or underwater pelletization. The pelletized material may be packaged, stored and transported. In one embodiment the pellets are packaged into metal foil lined plastic bags, typically polypropylene bags, or metal foil lined paper bags. Substantially all of the air can be evacuated from the pellet filled bags.

In one embodiment, the thermoplastic composition is substantially free of visible particulate impurities. Visible particulates or “black specks” are dark or colored particulates generally visible to the human eye without magnification and having an average diameter of 40 micrometers or greater. Although some people are able to without magnification visually detect particles having an average diameter smaller than 30 micrometers and other people can detect only particles having an average diameter larger than 40 micrometers, the terms “visible particles,” “visible particulates,” and “black specks” when used herein without reference to a specified average diameter means those particulates having an average diameter of 40 micrometers or greater. As used herein, the term “substantially free of visible particulate impurities” when applied to the thermoplastic composition means that when the composition is injection molded to form 5 plaques having dimensions of 75 millimeters×50 millimeters and having a thickness of 3 millimeters and the plaques are visually inspected for black specks with the naked eye the total number of black specks for all five plaques is less than or equal to 100, or, more specifically, less than or equal to 70, or, even more specifically, less than or equal to 50.

In one embodiment the pellets are melted and the composition applied to the conductor by a suitable method such as extrusion coating to form an covered wire. For example, a coating extruder equipped with a screw, crosshead, breaker plate, distributor, nipple, and die can be used. The melted thermoplastic composition forms a covering disposed over a circumference of the conductor. Extrusion coating may employ a single taper die, a double taper die, other appropriate die or combination of dies to position the conductor centrally and avoid die lip build up.

In one embodiment, the composition is applied to the conductor to form a covering disposed over the conductor. Additional layers may be applied to the covering.

In one embodiment the composition is applied to a conductor having one or more intervening layers between the conductor and the covering to form a covering disposed over the conductor. For instance, an optional adhesion promoting layer may be disposed between the conductor and covering. In another example the conductor may be coated with a metal deactivator prior to applying the covering. In another example the intervening layer comprises a thermoplastic or thermoset composition that, in some cases, is foamed.

The conductor may comprise a single strand or a plurality of strands. In some cases, a plurality of strands may be bundled, twisted, or braided to form a conductor. Additionally, the conductor may have various shapes such as round or oblong. The conductor may be any type of conductor used to transmit a signal. Exemplary signals include optical, electrical, and electromagnetic. Glass fibers are one example of an optical conductor. Suitable electrical conductors include, but are not limited to, copper, aluminum, lead, and alloys comprising one or more of the foregoing metals.

The cross-sectional area of the conductor and thickness of the covering may vary and is typically determined by the end use of the covered conductor. In one embodiment the covered conductor is an covered wire and the covered wire can be used as electric wire without limitation, including, for example, for harness wire for automobiles, wire for household electrical appliances, wire for electric power, wire for instruments, wire for information communication, wire for electric cars, as well as ships, airplanes, and the like. In one embodiment the covered conductor is an optical cable and can be used in interior applications (inside a building), exterior applications (outside a building) or both interior and exterior applications. Exemplary applications include data transmission networks and voice transmission networks such as telephone networks and local area networks (LAN).

In one embodiment the conductor has a cross sectional area of 0.10 square millimeters to 4.5 square millimeters and the covering has a thickness of 0.15 millimeters to 1.0 millimeters.

In some embodiments it may be useful to dry the thermoplastic composition before extrusion coating. Exemplary drying conditions are 60-90° C. for 2-20 hours. Additionally, in one embodiment, during extrusion coating, the thermoplastic composition is melt filtered, prior to formation of the coating, through one or more filters having opening diameters of 20 micrometers to 150 micrometers. Within this range, the openings diameters may be greater than or equal to 30 micrometers, or more specifically greater than or equal to 40 micrometers. Also within this range the openings diameters may be less than or equal to 130 micrometers, or, more specifically, less than or equal to 110 micrometers. The coating extruder may comprise one or more filters as described above.

In one embodiment, during extrusion coating, the thermoplastic composition is melt filtered, prior to formation of the coating, through one or more filters having opening diameters wherein the filter openings have a maximum diameter that is less than or equal to half of the thickness of the covering that will be applied to the conductor.

In another embodiment the melt filtered mixture produced by melt mixing is not pelletized. Rather the molten melt filtered mixture is formed directly into a coating for the conductor using a coating extruder that is in tandem with the melt mixing apparatus, typically a compounding extruder. The coating extruder may comprise one or more filters as described above.

It is contemplated that in some embodiments the thermoplastic composition may be extruded or otherwise formed into a tube that will provide a covering. The conductor and optional intervening layer may be inserted into the tube to form the covered conductor.

A color concentrate or masterbatch may be added to the composition prior to or during the extrusion coating. When a color concentrate is used it is typically present in an amount less than or equal to 3 weight percent, based on the total weight of the composition. In one embodiment dye and/or pigment employed in the color concentrate is free of chlorine, bromine, and fluorine. As appreciated by one of skill in the art, the color of the composition prior to the addition of color concentrate may impact the final color achieved and in some cases it may be advantageous to employ a bleaching agent and/or color stabilization agents. Bleaching agents and color stabilization agents are known in the art and are commercially available.

The extruder temperature during extrusion coating is generally less than or equal to 320° C., or, more specifically, less than or equal to 310° C., or, more specifically, less than or equal to 290° C. Additionally the processing temperature is adjusted to provide a sufficiently fluid molten composition to afford a covering for the conductor, for example, higher than the melting point of the thermoplastic composition, or more specifically at least 10° C. higher than the melting point of the thermoplastic composition.

After extrusion coating the covered conductor is usually cooled using a water bath, water spray, air jets, or a combination comprising one or more of the foregoing cooling methods. Exemplary water bath temperatures are 20 to 85° C.

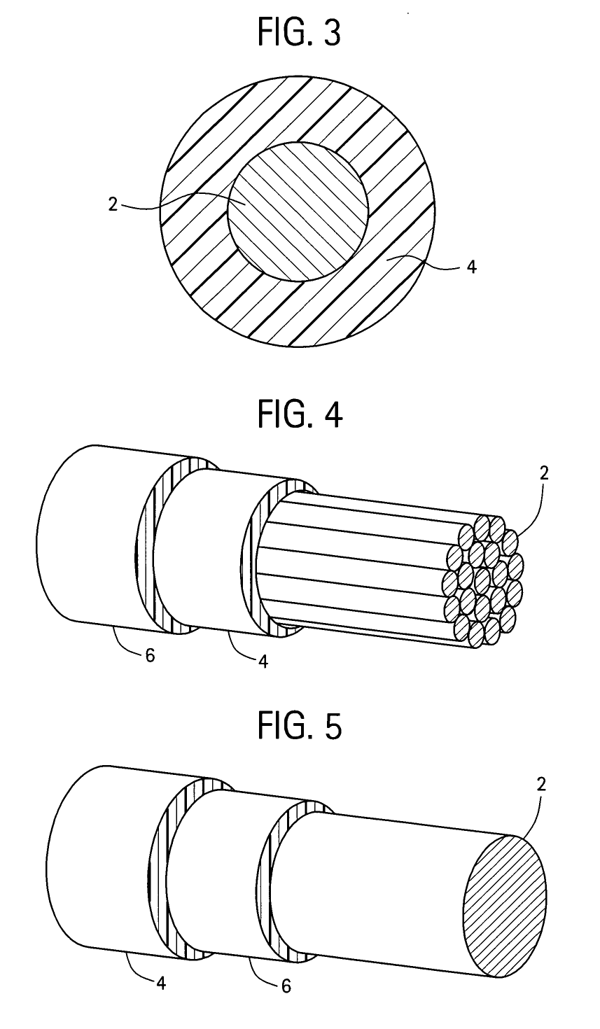

A cross-section of an exemplary covered conductor is seen in FIG. 3. FIG. 3 shows a covering, 4, disposed over a conductor, 2. In one embodiment, the covering, 4, comprises a foamed thermoplastic composition. Perspective views of exemplary covered conductors are shown in FIGS. 4 and 5. FIG. 4 shows a covering, 4, disposed over a conductor, 2, comprising a plurality of strands and an optional additional layer, 6, disposed over the covering, 4, and the conductor, 2. In one embodiment, the covering, 4, comprises a foamed thermoplastic composition. Conductor, 2, can also comprise a unitary conductor. FIG. 5 shows a covering, 4, disposed over a unitary conductor, 2, and an intervening layer, 6. In one embodiment, the intervening layer, 6, comprises a foamed composition. Conductor, 2, can also comprise a plurality of strands.

Alternatively the composition may be molded or extruded to form articles such as sheets or trays when it is desirable for such articles to have combination of chemical resistance, heat aging, abrasion resistance and impact strength.

The covered conductors include, without limitation, those that carry an electric current, an electric signal, a light signal and the like. Exemplary conductors include wire (cable) used to connect a vehicle and a trailer, wires used in medical equipment including in vivo medical equipment, wire for use inside of buildings, wire for use outside of buildings, and the like. In addition to covered conductors the thermoplastic composition may be useful in aircraft wire guides, aircraft flooring, and flexible tubing—particularly in the medical field.

The composition and covered wire are further illustrated by the following non-limiting examples.

### EXAMPLES

The following examples were prepared using the materials listed in Table 1.

TABLE 1

| Component | Description |
|---|---|
| PPE-0.33 IV | A poly(2,6-dimethylphenylene ether) having an intrinsic viscosity |
| | of 0.33 dl/g as measured in chloroform at 25° C. and commercially |
| | available from General Electric. |
| PPE-0.46 IV | A poly(2,6-dimethylphenylene ether) with an intrinsic viscosity of |
| | 0.46 dl/g as measured in chloroform at 25° C. commercially |
| | available from General Electric |
| KG1650 | A polyphenylethylene-poly(ethylene/butylene)-polyphenylethylene |
| | block copolymer having a phenylethylene content of 32 weight |
| | percent, based on the total weight of the block copolymer and |
| | commercially available from Kraton Polymers. |
| PP | A polypropylene having a melt flow rate of 1.5 g/10 min |
| | determined according to ASTM D1238 as described above and |
| | commercially available from Sunoco Chemicals under the tradename |
| | D-015-C2. |
| KG 1701 | A styrene-(ethylene/propylene) block copolymer commercially available |
| | from Kraton Polymers. |
| Kraton A | A styrene-(ethylene/propylene-styrene)-styrene copolymer |
| | commercially available from Kraton Polymers under the grade |
| | name RP6936 having a styrene content of 39 weight percent, based |
| | on the total weight of the block copolymer. |
| Tuftec H1043 | A polyphenylethylene-poly(ethylene/butylene)-polyphenylethylene |
| | block copolymer having a phenylethylene content of 67 weight |
| | percent, based on the total weight of the block copolymer and |
| | commercially available from Asahi Chemical |
| PP-g-PS | A polypropylene-graft-polystyrene commercially available from |
| | Crompton under the name Interloy ® P1045H1. |
| BPADP | Tetraphenyl bisphenol A diphosphate (CAS 181028-79-5) |

### Examples 1-16

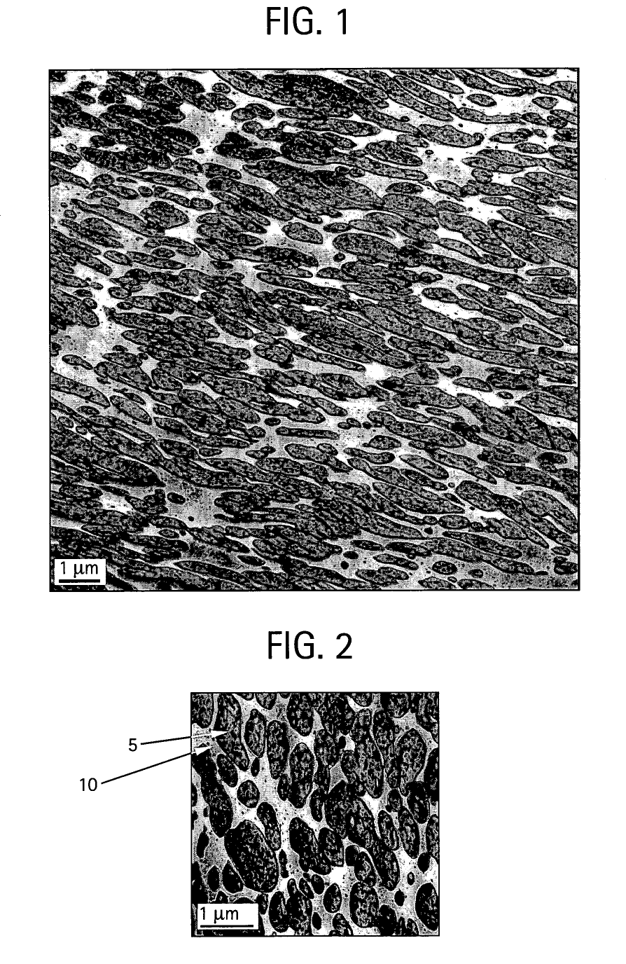

Examples 1-16 were made by combining the components in an twin screw extruder. The PPE and polymeric compatibilizer were added at the feedthroat and the PP was added downstream. The BPADP, when present, was added by a liquid injector in the second half of the extruder. The extruded material was injected molded into test specimens for physical property testing. The physical properties and their test methods are listed in Table 2. Testing according to ASTM D638-03 employed Type I samples injection molded using the same conditions as flexural modulus samples. Tensile elongation was measured at a speed of 50 millimeters per minute. Megapascals are abbreviated as MPa, Joules are abbreviated as J, Newtons are abbreviated as N, and meters are abbreviated as m. The compositions of the Examples are listed in Table 3. The data is listed in Table 4. The deflection temperature and flexural modulus values are an average of 3 samples. The remaining values are an average of 5 samples. A transmission electron micrograph of the morphology of Example 5 is shown in FIG. 1. FIG. 2 is a transmission electron micrograph of Example 5 showing the particles (5) with the boundaries (10) marked in preparation for determination of average diameter and particle area. Example 5 had an average diameter of 0.96 micrometers and an average particle area of 0.32 square micrometers. The average values were determined based on 129 particles.

TABLE 2

| Physical Property | Units | Test Method |
|---|---|---|
| Elongation at Yield-Avg | % | ASTM D638-03 |
| Elongation at Break-Avg | % | ASTM D638-03 |
| Stress at Break-Avg | MPa | ASTM D638-03 |
| Stress at Yield-Avg | MPa | ASTM D638-03 |
| Modulus of Elasticity | MPa | ASTM D638-03 |
| Deflection temp-Avg | ° C. | ASTM D648-04 |
| Energy to failure - 23 C. Avg | J | ASTM D3763-03 |
| Energy to max load - 23 C. Avg | J | ASTM D3763-03 |
| Max Load-Avg | N | ASTM D3763-03 |
| Energy to max load - 30 C. | J | ASTM D3763-03 |
| Energy to failure - 30 C. | J | ASTM D3763-03 |
| Max Load - 30 C. | N | ASTM D3763-03 |
| Impact Strength Avg | J/m | ASTM D256-03 |
| Flexural Modulus Avg | MPa | ASTM D790-03 |

TABLE 3

| Component | 1* | 2* | 3* | 4 | 5 | 6 | 7 | 8 | 9* | 10* | 11 | 12* | 13* | 14* | 15 | 16 |
|---|---|---|---|---|---|---|---|---|---|---|---|---|---|---|---|---|
| PPE-0.33 IV | — | — | — | — | — | — | — | — | — | — | — | 50 | 50 | 50 | 50 | — |
| PPE-0.46 IV | 50 | 50 | 50 | 50 | 50 | 50 | 50 | 50 | 30 | 30 | 30 | — | — | — | — | 49 |
| PP PD 403 | 40 | 40 | 40 | 40 | 40 | 40 | 40 | 40 | 60 | 60 | 60 | 40 | 40 | 40 | 40 | 34 |
| KG1650 | 10 | — | — | 5 | — | 7.5 | — | — | 10 | — | 5 | 10 | — | | 5 | 5 |
| Tuftec | — | 10 | — | — | 5 | — | 7.5 | — | — | — | — | — | 10 | — | — | — |
| H1043 | | | | | | | | | | | | | | | | |
| KG1701 | — | — | 10 | 5 | 5 | 2.5 | 2.5 | 5 | — | 10 | 5 | — | — | 10 | 5 | 5 |
| Kraton A | — | — | — | — | — | — | — | 5 | — | — | — | — | — | — | — | — |
| BPADP | — | — | — | — | — | — | — | — | — | — | — | — | — | — | — | 7 |

*Comparative examples

TABLE 4

| Property | 1* | 2* | 3* | 4 | 5 | 6 | 7 |
|---|---|---|---|---|---|---|---|
| Elongation at Yield-Avg | 8 | 8 | 4 | 26 | 8 | 35 | 13 |
| Elongation at Break-Avg | 59 | 98 | 4.0 | 41 | 22 | 85.8 | 71 |
| Stress at Break-Avg | 32.3 | 38.4 | 19.8 | 30.0 | 35.6 | 31.5 | 35.7 |
| Stress at Yield-Avg | 35.5 | 43.5 | 19.9 | 30.2 | 37.3 | 32.5 | 42.5 |
| Modulus of Elasticity | 2906 | 4118 | 1136 | 2404 | 3330 | 1162 | 1842 |
| Deflection temp-Avg | 151 | 148 | 80 | 130 | 146 | 127 | 145 |
| Energy to failure - 23 C. Avg | 25.2 | 40.1 | 29.2 | 31.5 | 36.0 | 37.9 | 41.2 |
| Energy to max load - 23 C. | 23.5 | 28.2 | 24.8 | 25.0 | 27.0 | 31.7 | 29.5 |
| Avg | | | | | | | |
| Max Load-Avg | 3150 | 3600 | 2850 | 3150 | 3410 | 3500 | 3740 |
| Energy to max load - 30 C. | 3.1 | 24.5 | 31.2 | 31.3 | 31.5 | 19.4 | 32.1 |
| Energy to failure - 30 C. | 3.4 | 25.6 | 36.9 | 33.5 | 36.1 | 20.3 | 35.1 |
| Max Load - 30 C. | 1406 | 4102 | 4144 | 4261 | 4469 | 3270 | 4610 |
| Impact Strength Avg | 123 | 152 | 124 | 187 | 186 | 169 | 192 |
| Flexural Modulus Avg | 1430 | 1630 | 739 | 1180 | 1370 | 1000.0 | 1580 |

| Property | 8 | 9* | 10* | 11 | 12* | 13* | 14* | 15 | 16 |
|---|---|---|---|---|---|---|---|---|---|
| Elongation at Yield-Avg/0 | 33 | 26 | 6 | 9 | 15 | 7 | 5 | 16 | 21 |
| Elongation at Break-Avg | 56 | 220 | 8 | 61 | 79 | 100 | 6 | 43 | 52 |
| Stress at Break-Avg | 31.0 | 27.0 | 20.3 | 19.5 | 36.0 | 38.3 | 26.3 | 31.8 | 36.4 |
| Stress at Yield-Avg | 31.3 | 28.5 | 21.8 | 24.0 | 35.1 | 44.2 | 26.8 | 33.7 | 37.8 |
| Modulus of Elasticity | 1010 | 1234 | 954 | 1028 | 1500 | 2480 | 1392 | 1508 | 1362 |
| Deflection temp-Avg | 142 | 100 | 70 | 82 | 146 | 154 | 119 | 140 | 129 |
| Energy to failure - 23 C. Avg | 35.4 | 24.6 | 31.7 | 37.5 | 41.0 | 43.4 | 32.5 | 40.1 | 40.0 |
| Energy to max load - 23 C. | 30.6 | 20.6 | 23.2 | 26.1 | 30.0 | 30.0 | 27.3 | 28.4 | 28.1 |
| Avg | | | | | | | | | |
| Max Load-Avg | 3440 | 2700 | 2600 | 2950 | 3510 | — | 3180 | 3330 | 3430 |
| Energy to max load - 30 C. | 28.2 | 4.30 | 17.9 | 23.2 | 17.7 | 10.5 | 29.9 | 29.7 | 27.2 |
| Energy to failure - 30 C. | 29.4 | 4.8 | 19.3 | 28.1 | 18.7 | 11.4 | 34.4 | 37.0 | 32.8 |
| Max Load - 30 C. | 4280 | 1490 | 3250 | 3490 | 3545 | 2531 | 4280 | 4155 | 33 |
| Impact Strength Avg | 254 | 126 | 155 | 200 | 237 | 155 | 227 | 286 | 462 |
| Flexural Modulus Avg | 922 | 989 | 675 | 790 | 1170 | 1620 | 1020 | 1100 | 1340 |

*Comparative examples

When the examples that employ a mixture of a diblock and a triblock copolymers are compared to the analogous comparative examples employing similar amounts of the same type of PPE a notable increase is seen in the impact strength while maintaining performance in the other measured properties.

### Examples 17-26

Examples 17-26 were made by combining the components in an twin screw extruder. The PPE and polymeric compatibilizer were added at the feedthroat and the PP was added downstream. The BPADP, when present, was added by a liquid injector in the second half of the extruder. The extruded material was injected molded into test specimens for physical property testing. The physical properties and their test methods are listed in Table 2. The compositions of the Examples are listed in Table 5. The data is listed in Table 6.

TABLE 5

| Com- | | | | | | | | | | |
|---|---|---|---|---|---|---|---|---|---|---|
| ponent | 17* | 18* | 19* | 20 | 21 | 22 | 23* | 24* | 25* | 26 |
| PPE-0.33 | — | — | — | — | — | — | 50 | 50 | 50 | — |
| IV | | | | | | | | | | |
| PPE-0.46 | 50 | 50 | 50 | 50 | 50 | 50 | — | — | — | 49 |
| IV | | | | | | | | | | |
| PP PD | 40 | 40 | 40 | 40 | 40 | 40 | 40 | 40 | 40 | 34 |
| 403 | | | | | | | | | | |
| KG1650 | 10 | — | — | — | 5 | — | 10 | — | | — |
| Tuftec | — | 10 | — | — | — | 5 | — | 10 | — | — |
| H1043 | | | | | | | | | | |
| KG1701 | — | — | 10 | — | — | — | — | — | 10 | — |
| Kraton A | — | — | — | 10 | 5 | 5 | — | — | — | 10 |
| BPADP | — | — | — | — | — | — | — | — | — | 7 |

*Comparative examples

TABLE 6

| Property | 17* | 18* | 19* | 20 | 21 |
|---|---|---|---|---|---|
| Elongation at Yield-Avg | 8 | 8 | 4 | 27 | 26 |
| Elongation at Break-Avg | 59 | 98 | 4.0 | 160 | 170 |
| Stress at Break-Avg | 32.3 | 38.4 | 19.8 | 38.2 | 38.9 |
| Stress at Yield-Avg | 35.5 | 43.5 | 19.9 | 36.2 | 35.8 |
| Modulus of Elasticity | 2906 | 4118 | 1136 | 991 | 1048 |
| Deflection temp-Avg | 151 | 148 | 80 | 129 | 127 |
| Energy to failure - 23 C. | 25.2 | 40.1 | 29.2 | 37.9 | 43.1 |
| Avg | | | | | |
| Energy to max load - | 23.5 | 28.2 | 24.8 | 29.6 | 30.2 |
| 23 C. Avg | | | | | |
| Max Load-Avg | 3150 | 3600 | 2850 | 3490 | 3450 |
| Energy to max load - | 3.1 | 24.5 | 31.2 | 35.7 | 34.0 |
| 30 C. | | | | | |
| Energy to failure - 30 C. | 3.4 | 25.6 | 36.9 | 40.9 | 40.1 |
| Max Load - 30 C. | 1406 | 4102 | 4144 | 4580 | 4460 |
| Impact Strength Avg | 123 | 152 | 124 | 222 | 249 |
| Flexural Modulus Avg | 1430 | 1630 | 739 | 1290 | 961 |
| Property | 22 | 23* | 24* | 25* | 26 |
| Elongation at Yield- | 16 | 15 | 7 | 5 | 15 |
| Avg/0 | | | | | |
| Elongation at Break-Avg | 170 | 79 | 100 | 6 | 110 |
| Stress at Break-Avg | 40.0 | 36.0 | 38.3 | 26.3 | 41.8 |
| Stress at Yield-Avg | 40.5 | 35.1 | 44.2 | 26.8 | 41.6 |
| Modulus of Elasticity | 1427 | 1500 | 2480 | 1392 | 1322 |
| Deflection temp-Avg | 140 | 146 | 154 | 119 | 129 |
| Energy to failure - 23 C. | 42.6 | 41.0 | 43.4 | 32.5 | 43.9 |
| Avg | | | | | |
| Energy to max load - | 29.8 | 30.0 | 30.0 | 27.3 | 29.4 |
| 23 C. Avg | | | | | |
| Max Load-Avg | 3600 | 3510 | — | 3180 | 3620 |
| Energy to max load - | 31.6 | 17.7 | 10.5 | 29.9 | 34.2 |
| 30 C. | | | | | |
| Energy to failure - 30 C. | 35.5 | 18.7 | 11.4 | 34.4 | 41.1 |
| Max Load - 30 C. | 4490 | 3545 | 2531 | 4280 | 41 |
| Impact Strength Avg | 253 | 237 | 155 | 227 | 458 |
| Flexural Modulus Avg | 1250 | 1170 | 1620 | 1020 | 1250 |

*Comparative examples

When the examples are compared to the analogous comparative examples employing similar amounts of the same type of PPE a significant increase, and in some cases a near doubling, in impact strength over the comparative examples is seen while maintaining performance in the other physical property tests.

### Examples 27-33

Examples 27-33 were made by combining the components in an twin screw extruder. The PPE and a polypropylene-graft-polystyrene polymeric compatibilizer were added at the feedthroat and the PP was added downstream. The extruded material was injected molded into test specimens for physical property testing. The physical properties and their test methods are listed in Table 2. The compositions of the Examples are listed in Table 7. The data is listed in Table 8.

TABLE 7

| Component | 27* | 28* | 29 | 30 | 31 | 32 | 33 |
|---|---|---|---|---|---|---|---|
| PPE-0.33 IV | — | 50 | 50 | 50 | 50 | 50 | 52 |
| PPE-0.46 IV | 50 | — | — | — | — | — | — |
| PP PD 403 | 40 | 40 | 40 | 40 | 40 | 40 | 29 |
| KG1650 | — | — | 5 | — | 7.5 | 2.5 | 5.0 |
| Tuftec | — | — | — | 5 | | | |
| H1043 | | | | | | | |
| PP-g-PS | 10 | 10 | 5 | 5 | 2.5 | 7.5 | 5 |

TABLE 8

| Property | 27* | 28* | 29 | 30 | 31 | 32 | 33 |
|---|---|---|---|---|---|---|---|
| Elongation at Yield- | 6.0 | 5.0 | 17 | 9.7 | 21 | 13 | 6.8 |
| Avg | | | | | | | |
| Elongation at Break- | 6.5 | 5.1 | 26 | 43 | 65 | 18 | 9.5 |
| Avg | | | | | | | |
| Stress at Break-Avg | 47.1 | 39.8 | 36.7 | 38.4 | 33.8 | 37.7 | 45.2 |
| Stress at Yield-Avg | 47.1 | 39.8 | 37.1 | 44.8 | 36.3 | 38.0 | 45.1 |
| Modulus of Elasticity | 2020 | 1990 | 1522 | 1940 | 1346 | 1710 | 1918 |
| Deflection temp-Avg | 159 | 153 | 140 | 148 | 140 | 138 | 137 |
| Energy to failure - 23 C. | 1.20 | 0.840 | 19.0 | 32.6 | 36.8 | 2.58 | 1.90 |
| Avg | | | | | | | |
| Energy to max load - | 0.980 | 0.720 | 18.2 | 28.2 | 29.6 | 2.28 | 1.66 |
| 23 C. Avg | | | | | | | |
| Max Load-Avg | 625 | 536 | 3100 | 3810 | 3560 | 886 | 772 |
| Energy to max load - | 1.20 | 0.840 | 19.0 | 32.7 | 36.8 | 2.58 | 4.52 |
| 30 C. | | | | | | | |
| Energy to failure - | 1.70 | 2.18 | 2.16 | 9.76 | 23.1 | 1.32 | 1.12 |
| 30 C. | | | | | | | |
| Max Load - 30 C. | 2.08 | 2.56 | 2.50 | 10.4 | 24.7 | 1.58 | 1.70 |
| Impact Strength Avg | 18.7 | 14.2 | 55.2 | 67.2 | 92.9 | 36.4 | 75.0 |
| Flexural Modulus | 1950 | 1890 | 1390 | 1790 | 1250 | 1570 | 1920 |
| Avg | | | | | | | |

*Comparative example

As can be seen from the foregoing examples, compositions comprising polypropylene-graft-polystyrene in combination with a block copolymer show improved physical properties, such as impact strength and tensile elongation, when compared to compositions having only polypropylene-graft-polystyrene.

While the invention has been described with reference to a several embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

All cited patents, patent applications, and other references are incorporated herein by reference in their entirety.

1. A thermoplastic composition comprising:
a poly(arylene ether) having an initial intrinsic viscosity greater than 0.25 dl/g as measured in chloroform at 25° C.;
a polyolefin having a melt temperature greater than or equal to 120° C. and a melt flow rate of 0.3 to 15; and
a polymeric compatibilizer selected from the group consisting of
(i) a block copolymer wherein a central block is a controlled distribution copolymer, and
(ii) a combination of a polypropylene-polystyrene graft copolymer and a block copolymer;
wherein the poly(arylene ether) is present in an amount by weight greater than the amount of polyolefin by weight.

2. The composition of claim 1 wherein the composition is essentially free of an alkenyl aromatic resin.

3. The composition of claim 1, wherein the thermoplastic composition comprises particles comprising the poly(arylene ether) dispersed in a matrix comprising the polyolefin and the particles have an average diameter less than 5 micrometers.

4. The composition of claim 1, wherein the thermoplastic composition comprises particles comprising the poly(arylene ether) dispersed in a matrix comprising the polyolefin and the poly(arylene ether) particles have an average particle area less than or equal to 4 square micrometers.

5. The composition of claim 1, wherein the composition has a flexural modulus of 800-1800 Megapascals as determined by ASTM D790-03 at a speed of 1.27 millimeters per minute and a thickness of 3.2 millimeters.

6. The composition of claim 1, wherein the poly(arylene ether) has a hydroxy end group content of less than or equal to 6300 parts per million based on the total weight of the poly(arylene ether) as determined by Fourier Transform Infrared Spectrometry (FTIR)

7. The composition of claim 1, wherein the poly(arylene ether) is substantially free of visible particulate impurities.

8. The composition of claim 1, wherein the poly(arylene ether) is substantially free of particulate impurities greater than about 15 micrometers.

9. The composition of claim 1, wherein the poly(arylene ether) is present in an amount of about 30 to about 65 weight percent, the polyolefin is present in an amount of 20 to 40 weight percent, and the block copolymer or combination of block copolymers is present in an amount of 2 to 20 weight percent, based on the combined weight of the poly(arylene ether), polyolefin, and polymeric compatibilizer.

10. The composition of claim 1, wherein the polyolefin comprises a polypropylene homopolymer, a polypropylene copolymer or a combination of a polypropylene homopolymer and a polypropylene copolymer.

11. The composition of claim 1 wherein the composition further comprises a flame retardant.

12. The composition of claim 1, further comprising one or more additives selected from the group consisting of antioxidants; fillers and reinforcing agents having an average particle size less than or equal to 10 micrometers, such as, for example, silicates, TiO₂, fibers, glass fibers, glass spheres, calcium carbonate, talc, and mica; mold release agents; UV absorbers; stabilizers such as light stabilizers and others; lubricants; plasticizers; pigments; dyes; colorants; anti-static agents; foaming agents; blowing agents; metal deactivators, and combinations comprising one or more of the foregoing additives

13. The composition of claim 1, wherein the poly(arylene ether) is a capped poly(arylene ether).

14. The composition of claim 1, wherein the composition is substantially free of visible particulate impurities.

15. The composition of claim 1, wherein the composition is substantially free of particulate impurities greater than about 15 micrometers.

16. A covered conductor comprising:
a conductor; and
a covering comprising a thermoplastic composition and the thermoplastic composition comprises:
a poly(arylene ether) having an initial intrinsic viscosity greater than 0.25 dl/g as measured in chloroform at 25° C.;
a polypropylene having a melt temperature greater than or equal to 120° C. and a melt flow rate of 0.3 to 15;
a polymeric compatibilizer selected from the group consisting of
(i) a block copolymer comprising a controlled distribution copolymer midblock, and
(ii) a combination of a polypropylene-polystyrene graft copolymer and a block copolymer;
wherein the poly(arylene ether) is present in an amount by weight greater than the amount by weight of polyolefin and
wherein the covering is disposed over the conductor.

17. The covered wire of claim 16 wherein the conductor comprises a single strand or a plurality of strands.

18. The covered wire of claim 17 wherein the plurality of strands may be bundled, twisted, or braided to form a conductor.

19. The covered wire of claim 16 wherein the conductor has a cross sectional area of 0.10 square millimeters to 4.5 square millimeters and the covering has a thickness of 0.15 millimeters to 1.0 millimeters.

20. The covered wire of claim 16, wherein the thermoplastic composition comprises particles comprising the poly(arylene ether) dispersed in a matrix comprising the polyolefin and the particles have an average diameter less than 5 micrometers.

21. The covered wire of claim 16, wherein the thermoplastic composition comprises particles comprising the poly(arylene ether) dispersed in a matrix comprising the polyolefin and the poly(arylene ether) particles have an average particle area less than or equal to 4 square micrometers.

22. The covered wire claim 16, wherein the composition has a flexural modulus of 800-1800 Megapascals as determined by ASTM D790-03 at a speed of 1.27 millimeters per minute and a thickness of 3.2 millimeters.

23. The covered wire claim 16, wherein the poly(arylene ether) is present in an amount of about 30 to about 65 weight percent, the polyolefin is present in an amount of 20 to 40 weight percent, and the block copolymer or combination of block copolymers is present in an amount of 2 to 20 weight percent, based on the combined weight of the poly(arylene ether), polyolefin, and polymeric compatibilizer.

24. The covered wire claim 16, wherein the polyolefin comprises a polypropylene homopolymer, a polypropylene copolymer or a combination of a polypropylene homopolymer and a polypropylene copolymer.

25. The covered wire of claim 16, wherein the thermoplastic composition further comprises a flame retardant.
